(19) United States
(12) Patent Application Publication
(10) Pub. No.: US 2022/0109202 A1
(43) Pub. Date: Apr. 7, 2022

(54) ENERGY STORAGE SYSTEM WITH TEMPERATURE CONTROL UNIT

(71) Applicant: TI Automotive Technology Center GmbH, Rastatt (DE)

(72) Inventors: Albert BOECKER, Ettlingen (DE); Matthias WINTER, Rastatt (DE); Thorsten SCHAEFER, Steinfeld (DE); Florian DEIBEL, Sinzheim (DE)

(21) Appl. No.: 17/553,203

(22) Filed: Dec. 16, 2021

Related U.S. Application Data
(63) Continuation of application No. PCT/IB2021/058966, filed on Sep. 29, 2021.

(30) Foreign Application Priority Data
Sep. 30, 2020 (EP) 20199326.8

(51) Int. Cl. H01M 10/6557; H01M 50/209; H01M 50/211; H01M 50/213; H01M 50/249; H01M 10/613; H01M 10/625; H01M 10/643; H01M 10/647

(52) U.S. Cl. CPC H01M 10/6557; H01M 50/209; H01M 50/211; H01M 50/213; H01M 2220/20; H01M 10/613; H01M 10/625; H01M 10/643; H01M 10/647; H01M 50/249

(57) ABSTRACT

An energy storage system, comprising a housing in which several energy storage cells are arranged, wherein a temperature control unit is arranged in the housing, wherein the temperature control unit contacts the energy storage cells at least in sections, wherein the temperature control unit has a shape which is adapted at least in sections to the shape of the energy storage cells, wherein the temperature control unit is designed as a blow molded part, and a method of manufacturing an energy storage system.

### RELATED APPLICATIONS

The present disclosure is a continuation of PCT Application PCT/IB2021/058966, filed on Sep. 29, 2021, and also claims the benefit of priority to European Application 20199326.8, filed on Sep. 30, 2020, the entire contents of which are incorporated herein by reference.

### FIELD

The disclosure relates to an energy storage system comprising a housing in which several energy storage cells are arranged, wherein a temperature control unit is arranged in the housing, wherein the temperature control unit contacts the energy storage cells at least in sections, wherein the temperature control unit has a shape adapted at least in sections to the shape of the energy storage cells. The disclosure also relates to a vehicle having such an energy storage system.

### BACKGROUND

Such an energy storage system is known, for example, from WO 2019/046871 A1. Energy storage systems of this kind are particularly suitable for stationary systems and for use in mobile systems, for example in vehicles with purely electric or supplementary electric drives. An energy storage system frequently used for electromobility comprises rechargeable energy storage cells in the form of batteries, with lithium-ion batteries being used particularly frequently. Such batteries consist of several energy storage cells, which are installed together in a housing. In this case, the housing, which accommodates several energy storage cells, forms an energy storage module.

Electrochemical batteries, such as lithium-ion batteries, exhibit the highest possible capacity only within a small temperature spectrum. Therefore, depending on the environmental conditions, it is necessary to cool or heat the energy storage cells arranged in the housing. For this purpose, it is known from the above-mentioned prior art to arrange a temperature control unit with hoses in the housing, wherein the hoses are placed between the energy storage cells. The hoses are flexible and nestle up against the energy storage cells when a pressurized temperature control medium is conveyed through the temperature control unit. However, we have discovered that it is problematic here that a mechanical force can be exerted on the energy storage cells by the hose-like temperature control unit, in particular if a temperature control medium under pressure is conveyed through the temperature control unit. Mechanical forces can also result from braking processes or driving along curves and cause damage to the energy storage system. Another problem we have found is that, depending on the pressure conditions inside the temperature control unit, the contact surface between the temperature control unit and the energy storage cells can be reduced, which can lead to local overheating and damage.

### SUMMARY

An object of the disclosure is to provide a temperature control unit for an energy storage system, which enables high heat transfer with good mechanical properties while being easily mountable.

This object is achieved using the features of claim 1. The dependent claims make reference to advantageous embodiments.

The energy storage system according to the disclosure comprises a housing in which several energy storage cells are arranged, wherein a temperature control unit is arranged in the housing, wherein the temperature control unit contacts the energy storage cells at least in sections, wherein the temperature control unit has a shape adapted at least in sections to the shape of the energy storage cells, wherein the temperature control unit is formed as a blow molded part. Accordingly, the temperature control unit is formed from a dimensionally stable plastic, preferably a dimensionally stable thermoplastic.

The shaping of the temperature control unit takes place in situ within the housing and between the energy storage cells. To manufacture the temperature control unit, a preform is placed between the energy storage cells and shaped by blow molding. In the process, the preform nestles up against the energy storage cells, creating a particularly large contact area between the energy storage cells and the temperature control unit. This in turn results in particularly good heat transfer. After completion of the blow molding process, the temperature control unit is dimensionally stable, which means that no mechanical loads are transferred to the energy storage cells, especially during operation of the energy storage system.

However, because the temperature control unit is dimensionally stable, it can also act as a support device and fix the energy storage cells in place. Furthermore, the fact that the temperature control unit is formed as a blow molded part results in great flexibility with regard to the arrangement and design of the energy storage cells. In particular, it is not necessary to change the shape of the temperature control unit depending on the arrangement of the energy storage cells and the design of the energy storage cells. The shaping of the temperature control unit takes place automatically during the blow molding process, so that a large variety of shapes can be realized for the temperature control unit.

The energy storage cells can be designed as round cells. Such energy storage cells have a cylindrical shape and are arranged upright or lying down in the housing. In this case, the temperature control unit nestles up against the circumference of the cylindrical round cells. The temperature control unit is formed during the blow molding process, ensuring that the temperature control unit is in contact with the cylindrical wall of the round cells over a large area. The diameter and also the height of the round cells are irrelevant, since the shaping of the temperature control unit is carried out automatically depending on the shape of the energy storage cells. In alternative embodiments, the energy storage cells may be, for example, pouch cells or prismatic cells.

The temperature control unit may have at least one flow channel. For this purpose, the temperature control unit is designed as a hollow body with a flow channel. The flow channel allows temperature control medium to flow through the temperature control unit, absorbing heat emitted from the energy storage cells or releasing heat to the energy storage cells. In advantageous embodiments, it is also conceivable that a flow channel is divided into several sub-channels, which are separated from each other by a membrane or a wall, for example.

The temperature control unit can have contact sections, wherein the contact sections nestle up against the outer contour of the energy storage cells. This results in a particularly large contact area between the temperature control unit and the energy storage cells.

The temperature control unit can have several flow channels. In this embodiment, several separately formed preforms are arranged between the energy storage devices, wherein each preform forms a respective flow channel. As a result, the flow channels have a simple shape and the preforms are easily mountable. Furthermore, it is conceivable that a temperature control medium adapted to the heat or cold requirement flows through the flow channels. In this context, it is conceivable, for example, that in the event of a locally limited malfunction, the adjacent flow channels are subjected to a high volume flow of temperature control medium or to a colder temperature control medium.

The flow channels can be connected to a collector on the inflow side and/or on the outflow side. This means that all or at least some of the flow channels can be easily supplied with temperature control medium. Switchable valves can be arranged between the collector and the flow channels to control the volume flow of the temperature control medium flowing through the flow channels. Like the flow channels, the collectors can also be formed as blow molded parts.

The energy storage system may be part of a vehicle. In this case, the energy storage system provides electrical energy for an electric drive. The embodiment of the temperature control unit according to the disclosure in the form of a blow molded part is particularly advantageous in this context because the temperature control unit is adapted to the shape of the energy storage cells. On the one hand, this provides an extensive and efficient heat transfer between the temperature control unit and the energy storage cells and, on the other hand, the temperature control unit can absorb forces acting on the energy storage cells during driving, in particular during braking and driving along curves.

The collector can be in operative connection with the cooling circuit of a vehicle. In this embodiment, the temperature control unit of the energy storage system is connected to the efficient cooling circuit of the vehicle. The collector can be connected directly or indirectly to the cooling circuit.

The temperature control unit can be meander-shaped. In this case, the temperature control unit surrounds several energy storage cells in an arcuate manner, which can be arranged regularly and are separated into several rows by the temperature control unit.

The temperature control unit can be made of thermoplastic material. Thermoplastics are easy to process by blow molding. Additives may be added to the thermoplastic to improve thermal conductivity. Possible additives include, for example, metallic or carbonaceous particles. Furthermore, the matrix of the thermoplastic material may be provided with a fiber reinforcement to improve the mechanical properties.

A vehicle according to the disclosure comprises at least an assisting electric drive and an energy storage system comprising a temperature control unit as previously described.

The object of the disclosure is also achieved by a method of manufacturing a temperature control unit for an energy storage device comprising an array of energy storage cells, in which a preform is arranged in the array of energy storage cells and the temperature control unit is formed from the preform by blow molding. Accordingly, in the method according to the disclosure, the energy storage cells are first arranged in the housing and, if necessary, fixed in the housing. The preform is then arranged between the energy storage cells, wherein the arrangement of the preform may be performed in a meander-shaped manner. Alternatively, multiple preforms may be arranged between the energy storage cells. The temperature control unit is then shaped by means of blow molding. During this process, the material of the preform is heated and pressurized, causing the preform to plastically deform and partially nestle up against the energy storage cells. This results in a large contact area between the temperature control unit and the energy storage cells. After completion of the blow molding process, the temperature control unit is dimensionally stable and, in addition to its tempering function, can also form a support for the energy storage cells.

During blow molding, at least one functional element may be molded into or arranged in the temperature control unit. Flow channels of temperature control circuits can contain several functional elements required for the functioning of the temperature control unit. These are, for example, throttle valves, check valves, switchable valves, pumps, flow sensors and/or temperature sensors. In the energy storage system according to the disclosure, at least one of the functional elements described above may be arranged in the temperature control unit, for example within a flow channel, so that the functional element is in contact with the temperature control medium.

Due to the arrangement of the functional element within the energy storage system, between the energy storage cells, status parameters of the temperature control medium can be measured and also influenced directly in the areas to be tempered. Thereby, according to a first embodiment, the functional element may be formed directly from the base body, which is particularly considered for passive elements such as throttle valves. Alternatively, functional elements may be arranged in the preform such that they are positioned correctly in the temperature control unit after blow molding.

### BRIEF DESCRIPTION OF THE DRAWINGS

Some of the embodiments of the energy storage system according to the disclosure are explained in more detail below with reference to the figures. These show, schematically in each case:

FIG. 1 an energy storage system with multiple flow channels;

FIG. 2 an energy storage system with a meander-shaped temperature control unit;

FIG. 3 the manufacture of an energy storage system according to FIG. 1;

FIG. 4 the manufacture of an energy storage system with energy storage cells in the form of prismatic cells.

### DETAILED DESCRIPTION

The figures show an energy storage system 1 comprising a housing 2 in which several energy storage cells 3 are arranged. In this regard, the energy storage cells 3 may be round cells in a first embodiment and pouch cells in a second embodiment. Alternatively, however, the energy storage cells 3 may also be in the form of prismatic cells. The energy storage system 1 described here stores electrical energy for the electric drive and auxiliary units of an electric vehicle.

A temperature control unit 4 is arranged in the housing 2, wherein the temperature control unit 4 contacts the energy storage cells 3 at least in sections. In this regard, the temperature control unit 4 has a shape adapted in sections to the shape of the energy storage cells 3.

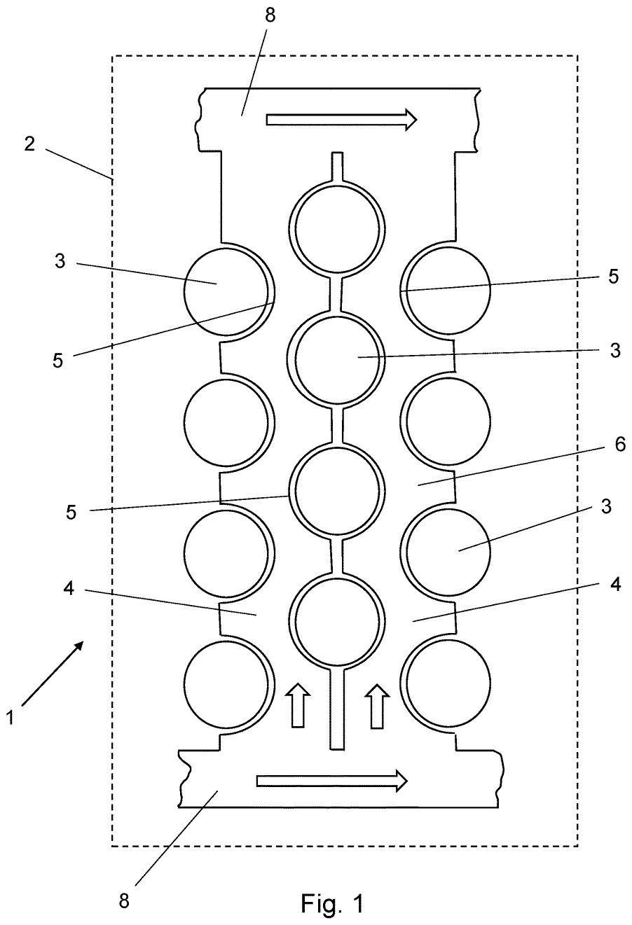

In the embodiment according to FIG. 1, the energy storage cells 3 are in the form of round cells and are placed upright in a housing 2. A temperature control unit 4 comprising several flow channels 6 is further arranged in the housing 2. Here, the flow channels 6 are arranged between the energy storage cells 3 such that the energy storage cells 3 are arranged in rows. The temperature control unit 4 in the form of the flow channels 6 has contact sections 5, wherein the contact sections 5 nestle up against the outer contour of the energy storage cells 3.

The flow channels 6 are connected to a collector 8 on the inflow side and on the outflow side. On the inflow side, temperature control medium is conveyed via the collector 8 in the direction of the flow channels 6, and via the collector 8 arranged on the outflow side, the temperature control medium is transported away from the flow channels 6. The collectors 8, like the flow channels 6, are formed as blow molded parts. The collector 8 is in operative connection with the cooling circuit of the electrically driven vehicle.

The temperature control unit 4 with flow channels 6 and collector 8 is made of thermoplastic material. To improve thermal conductivity, the matrix of the thermoplastic material is provided with thermally conductive particles in the form of metal or carbon powder.

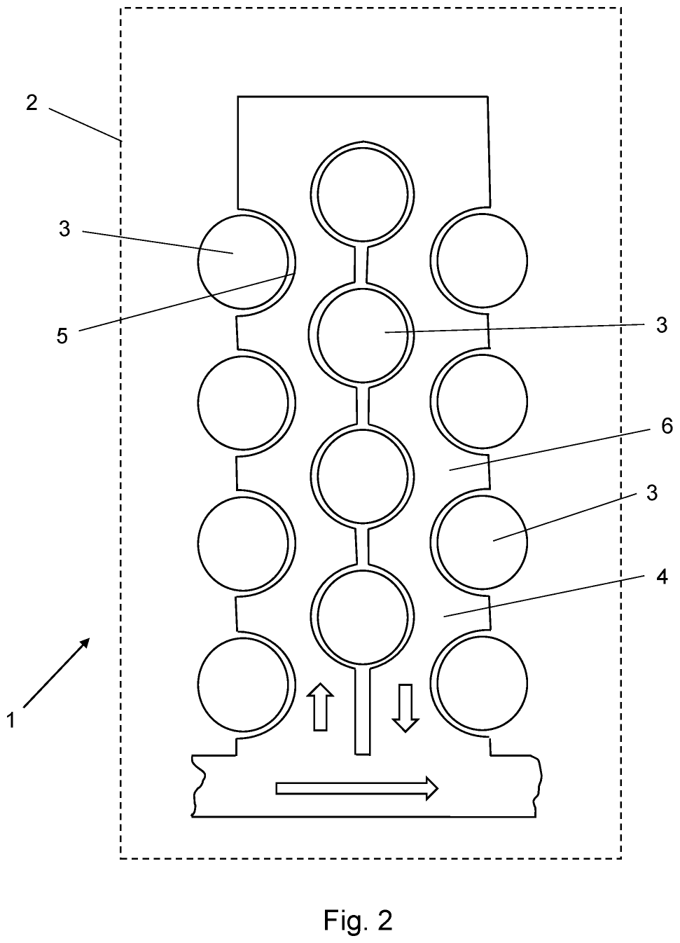

FIG. 2 shows an alternative embodiment of the energy storage system 1 described in FIG. 1. In the present embodiment, the temperature control unit 4 comprises a flow channel 6 which is formed in a meander-shaped manner and runs in an arcuate manner between the energy storage cells 3.

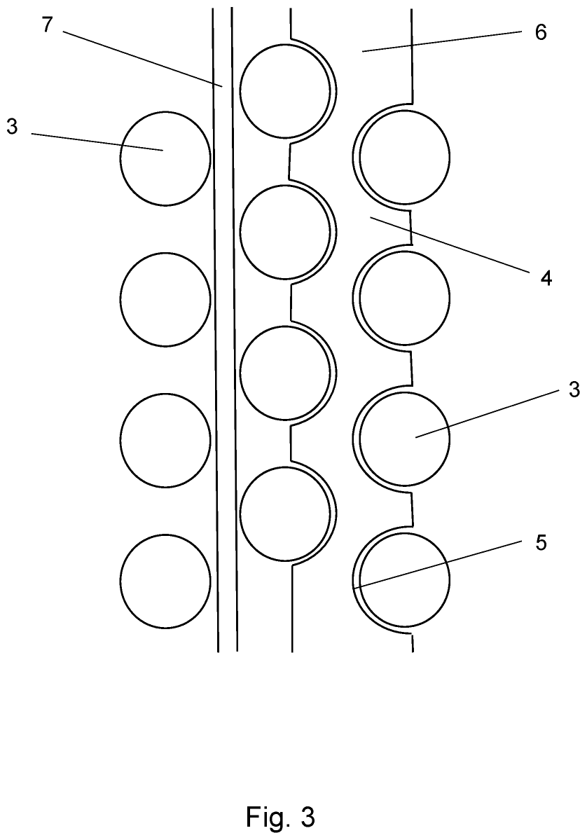

FIG. 3 shows a method of manufacturing the energy storage system 1 provided with the temperature control unit 4. In this case, the energy storage cells 3 are first arranged in the housing 2. In the present embodiment, the energy storage cells 3 are in the form of round cells which are arranged upright in the housing 2.

In a second step, preforms 7 are arranged between the energy storage cells 3, wherein the arrangement of the preforms 7 is performed such that the energy storage cells 3 are arranged in rows between the preforms 7. The preforms 7 are elongated hollow bodies. A functional element, for example a temperature and/or flow sensor, may be arranged in at least one preform 7.

In the next step, the temperature control unit 4 is formed from the preforms 7 by blow molding. As a result of the plastic deformation of the preforms 7 that occurs during blow molding, the preforms 7 expand and thereby come into contact with the energy storage cells 3. In this case, the preforms 7, or the temperature control unit 4 with flow channels 6 formed from the preforms 7, nestle up against the circumference of the energy storage cells 3. Contact sections 5 are formed from the flow channels 6, which are congruent with the circumference of the energy storage cells 3. This results in a large contact area between the temperature control unit 4 and the energy storage cells 3. During blow molding, the functional element is positioned correctly in the temperature control unit 4. Furthermore, a functional element may be formed directly from the preform 7 during blow molding.

The flow channels 6 are then connected to the collectors 8. In the present case, this is done by means of a welded joint.

In the left-hand section of the illustration, the energy storage system 1 can be seen with the preform 7 arranged between the energy storage cells 3. In the right-hand illustration, the temperature control unit 4 formed from the preform 7 can be seen, which is arranged between the energy storage cells 3 and is adapted to the shape of the energy storage cells 3.

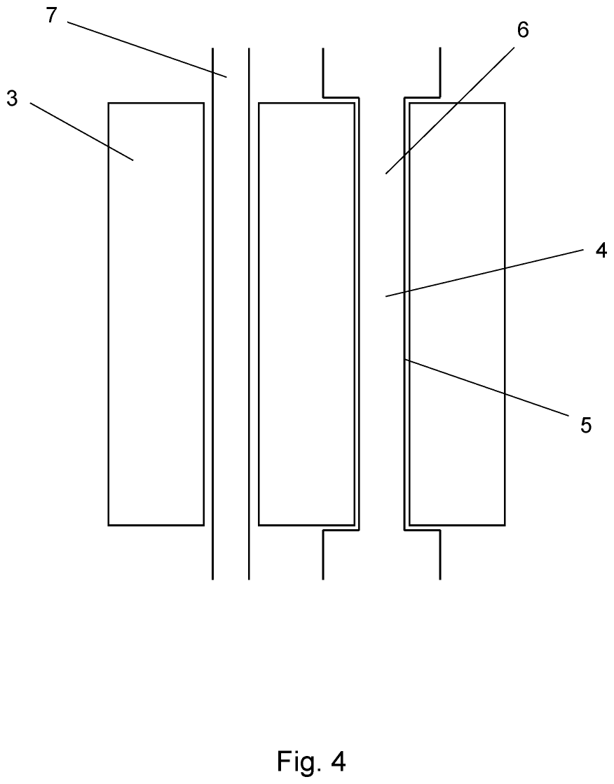

FIG. 4 shows an alternative method of manufacturing an energy storage system 1 according to FIG. 3. In the present embodiment, the energy storage cells 3 are in the form of prismatic cells. In this embodiment, preforms 7 are also arranged between energy storage cells 3 and the temperature control unit 4 is formed from the preforms 7 by blow molding. During this process, the preforms 7 nestle up against the outer contour of the energy storage cells 3, which are in the form of prismatic cells, resulting in a large contact area between the temperature control unit 4 and the energy storage cells 3. A comparable embodiment results when energy storage cells 3 in the form of pouch cells are used.

1. An energy storage system, comprising:
a housing in which several energy storage cells are arranged, wherein a temperature control unit is arranged in the housing,
wherein the temperature control unit contacts the energy storage cells at least in sections, wherein the temperature control unit has a shape which is adapted at least in sections to the shape of the energy storage cells, and wherein the temperature control unit is designed as a blow molded part.

2. The energy storage system according to claim 1, wherein the energy storage cells are designed as round cells.

3. The energy storage system according to claim 1, wherein the energy storage cells are prismatic cells or pouch cells.

4. The energy storage system according to claim 1, wherein the temperature control unit has at least one flow channel.

5. The energy storage system according to claim 1, wherein the temperature control unit has contact sections which nestle up against the outer contour of the energy storage cells.

6. The energy storage system according to claim 1, wherein the temperature control unit has several flow channels

7. The energy storage system according to claim 6, wherein the flow channels are connected to a collector on the inflow side and on the outflow side.

8. The energy storage system according to claim 1, wherein the energy storage system is part of a vehicle.

9. The energy storage system according to claim 7, wherein the collector is operatively connected to the cooling circuit of a vehicle.

10. The energy storage system according to any one of claim 1, wherein the temperature control unit is formed meander-shaped.

11. The energy storage system according to any one of claim 1, wherein the temperature control unit is formed from thermoplastic material.

12. A vehicle comprising at least an assisting electric drive and an energy storage system according to claim 1.

13. A method of manufacturing an energy storage system having a housing in which several energy storage cells are arranged, the method comprising:
arranging energy storage cells in a housing,
arranging a preform between the energy storage cells, and
forming the temperature control unit from the preform by blow molding.

14. The method according to claim 13, wherein a functional element is formed or arranged in the temperature control unit during the blow molding.
